(19) United States
(12) Patent Application Publication
(10) Pub. No.: US 2008/0195545 A1
(43) Pub. Date: Aug. 14, 2008

(54) METHOD, SYSTEM, AND COMPUTER PROGRAM PRODUCT FOR USING A PERSONAL COMMUNICATION DEVICE TO OBTAIN ADDITIONAL INFORMATION

(76) Inventor: Tetsuro MOTOYAMA, Cupertino, CA (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/673,387

(22) Filed: Feb. 9, 2007

(51) Int. Cl. H04L 9/00; G06F 17/30

(52) U.S. Cl. 705/51; 705/7

(57) ABSTRACT

A method of requesting information, including: receiving a request to process a transaction; identifying a user that sent the request; determining, based on a rule corresponding to the transaction and the identity of the user, that information needs to be obtained from the user before the transaction can be processed; accessing a database to obtain information corresponding to a mobile communication device of the user, the information indicating a contact address for the mobile communication device; contacting the mobile communication device using the information obtained from the database; and requesting additional information from the user.

### BACKGROUND OF THE INVENTION

1. Field of the Invention

The present invention relates generally to systems that require additional information from a user, and particularly to a system, method, and computer program product for contacting a user for additional information through use of the user's mobile communication device.

2. Description of the Related Art

Security is an important aspect in many corporate, commercial, and private activities. Entities want to protect their own interests by ensuring that sensitive information is accessed and used by appropriate people.

For example, a corporation may store confidential information on its servers, which is accessible to select personnel. Some personnel may have permission to print a hard-copy of the confidential information. To ensure that only authorized personnel create the hard-copy, a specially equipped printer may be used. The printer may be equipped with a key pad. The authorized person creating the hard-copy of the confidential information can enter an authorization code on the printer key pad. If the authorization code is verified, then the printer will proceed to produce the hard-copy.

The conventional method of securing the printout is to input the user name and password at the printer or use the ID card to allow the print out. However, the intended person may pass the user name and password or loan the ID card to another person. The conventional method may not be secure enough to restrict the delivery of the printout to the specified user.

In conventional credit card transactions, if there is a problem at the point of sale, the credit card company will deny the processing of the transaction. Such a problem might arise if the credit card company believes that an unauthorized user is attempting to use the credit card, or that a purchase is determined to be unusual for a particular card holder. The retailer may attempt to contact the credit card company to resolve the problem, or the retailer may ask their customer to use an alternate means to pay for the goods or services. If the authorized holder of the credit card is involved in the transaction, then the authorized holder may become frustrated with their credit card company. The credit card holder's recourse is to contact his or her credit card company. By the time this occurs, the holder may no longer have the opportunity to purchase the goods or services he or she attempted to purchase, and time has been wasted.

Furthermore, many corporations provide their employees with credit cards in the name of the corporation for use in paying for business related expenses. However, there is the potential for employees to misuse such a company credit card. One solution to limit misuse is to limit transactions to those which have received prior approval. However, this creates additional work and is time consuming in terms of man-hours wasted. Furthermore, this approach does not account for emergency or unexpected purchases, in which there is no time for prior approval.

Furthermore, conventional auditing involves the submission of receipts and credit card statements to corporate personnel in charge of auditing expenses. However, the receipts and credit card statements may not provide enough information to determine whether the transaction was appropriate.

In conventional auditing of corporate credit card use, there is no system in place to obtain additional information from the user of the company credit card, contemporaneously with the processing of the transaction. In most of the cases, the necessary information is collected through the company procedure later, such as filing the form required by the company using paper or an on-line electronic form.

### SUMMARY OF THE INVENTION

An object of the present invention is to address the above-identified and other limitations of conventional systems.

In one aspect of the present invention, a method of requesting information is provided. The method includes: receiving a request to process a transaction; identifying a user that sent the request; obtaining a rule corresponding to the transaction; determining, based on the rule corresponding to the transaction and the identity of the user, that information needs to be obtained from the user before the transaction can be processed; accessing a database to obtain information corresponding to a mobile communication device of the user, the information indicating a contact address for the mobile communication device; contacting the mobile communication device using the information obtained from the database; and requesting additional information from the user.

In another aspect of the method, the determining step includes: storing the contact address of the mobile communication device in correspondence with the identity of the user.

In another aspect of the method, the transaction is processing information on an image forming device.

In another aspect of the present invention, the transaction is processing information used in a purchase card transaction.

In another aspect of the method, the method includes: determining whether the additional information matches data stored for the user; processing the transaction if the additional information matches information; and creating an audit record that includes at least one of an identity of the user, the additional information, and data related to the transaction.

In another aspect of the method, the method further includes: determining a type of the mobile communication device; and obtaining, based on the determined type of the mobile communication device, an interface module used to communicate with the mobile communication device.

Another aspect of the present invention is a system for requesting information. The system includes: a target unit configured to receive a request to process a transaction, identify a user that sent the request, obtain a rule corresponding to the transaction, determine, based on the rule corresponding to the transaction and the identity of the user, that information needs to be obtained from the user before the transaction can be processed, access a database to obtain information corresponding to a mobile communication device of the user, the information indicating a contact address for the mobile communication device, contact the mobile communication device using the information obtained from the database, and request additional information from the user; and a mobile communication device configured to supply the additional information to the target unit.

In another aspect of the system, the target unit is configured to store the contact address of the mobile communication device in correspondence with the identity of the user.

In another aspect of the system, the transaction represents a process to be performed by an image forming device.

In another aspect of the system, the transaction represents a process to be performed in a purchase card transaction.

In another aspect of the system, the target unit is configured to determine whether the additional information matches data stored for the user; process the transaction if the additional information matches information; and create an audit record that includes at least one of an identity of the user, the additional information, and data related to the transaction.

In another aspect of the system, the target unit is configured to determine a type of the mobile communication device; and obtain, based on the determined type of the mobile communication device, an interface module used to communicate with the mobile communication device.

Another aspect of the invention is a computer program product encoded with instructions, which when executed by an information processing apparatus cause the information processing apparatus to perform a method embodying the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a system used to request and receive additional information from a user;

FIG. 2A is diagram illustrating an embodiment of the present invention where printing of a document requires receiving additional information from a user;

FIG. 2B is a diagram illustrating an embodiment of the present invention where a purchase card transaction requires receiving additional information from a user;

FIG. 3A is a flow chart showing a method embodying the present invention;

FIG. 3B is a flow chart continuing the method from FIG. 3A;

FIG. 4 is an exemplary table in a database that stores information used to contact the user via the user's mobile communication device;

FIG. 5 is flow chart illustrating a method of obtaining a interface module used to communicate with the user's mobile communication device;

FIG. 6 is a block diagram of a system embodying the present invention;

FIG. 7 is a flow chart illustrating a method of inputting a user name and password that are requested to be input at image forming device prior to print out; and

FIG. 8 is block diagram of a computer system capable of implementing the present invention.

### DETAILED DESCRIPTION OF THE PREFERRED EMBODIMENTS

Reference will now be made in detail to exemplary embodiments of the invention, examples of which are illustrated in the accompanying drawings. Wherever convenient, similar reference numbers will be used throughout the drawings to refer to the same or like parts. The implementations set forth in the following description do not represent all implementations consistent with the claimed invention. Instead, they are merely some examples of systems and methods consistent with the invention.

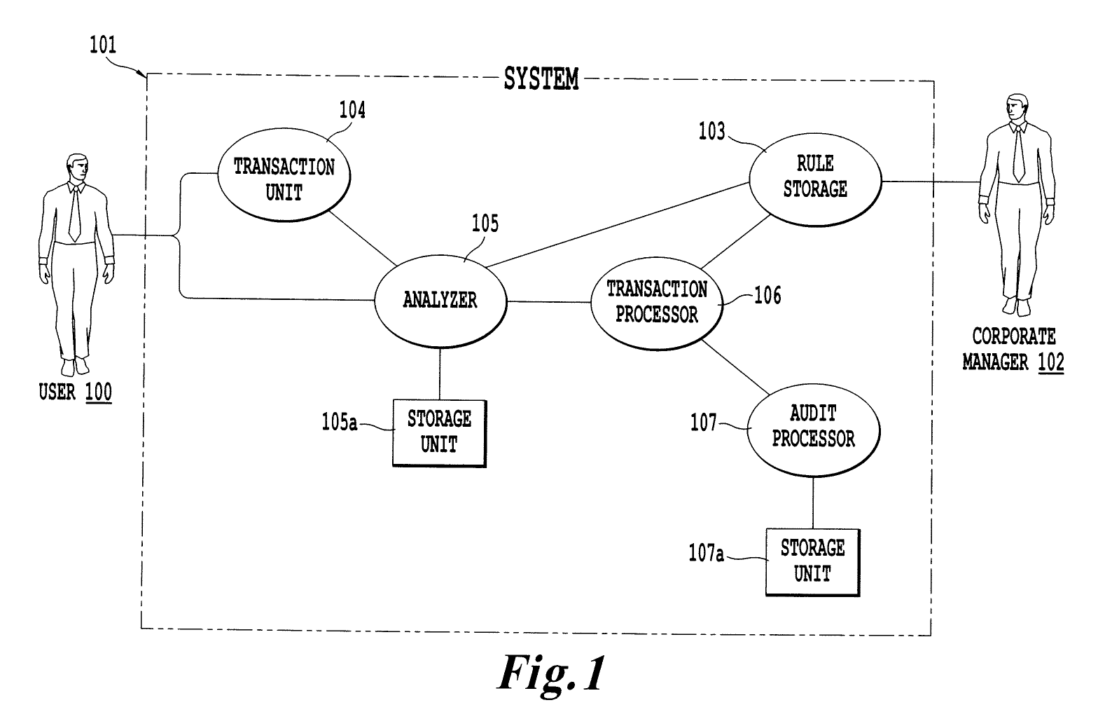

FIG. 1 is a block diagram of an exemplary system embodying the present invention. A system user 100 interacts with target system 101, which may be an image forming device (such as a printer, fax machine, copier, Multi-Function machine, etc.) or a credit card system (or any other purchase card systems). Although only a limited number of exemplary systems embodying the present invention will be discussed below, the present invention is applicable to any system that interacts with a user and requests authorization or other additional information from the user. Other systems include, but are not limited to, a security system to access gate/room, secure login system of a secure server, and a document control system.

A corporate manager sets one or more rules that govern when user 100 must supply additional information, such as a personal identification number (PIN), other type of authorization code, permission to print, denial to print, or reason of purchase. The rule is stored in rule storage device 103, which is configured to supply the rule to analyzer 105 as discussed below. Transaction unit 104 is configured to receive a transaction command from user 100. A transaction command, for example, is a command to print, copy, scan, or fax a particular document. Transaction unit 104 is further configured to supply the transaction command to analyzer 105. Analyzer 105 is configured to analyze the transaction input into the system and the user 100. For example, the analyzer 105 will determine who issued the transaction command and what document is involved in the transaction command. Analyzer 105 is further configured to receive the rule stored in rule storage device 103. Based on the rule, the transaction command, and the user, the analyzer 105 determines whether additional information is needed from user 105. If additional information is needed, analyzer 105 will contact the user through a personal communication device. The personal communication device may be a cell phone, a two-way pager, personal digital assistance (PDA), or any device that allows for two-way communication. Database 105a stores information regarding the user. Such information may include name, position, security clearance, email address, work phone number, cell phone number, home phone number, etc. Analyzer 105 is configured to access database 105a to obtain information used to contact the personal communication device of user 100.

User 100 will use his or her personal communication device to transmit the additional information to analyzer 105. Upon receipt of the additional information, the transaction command and the additional information are sent from the analyzer 105 to transaction processor 106. The transaction processor 106 is configured to interact with audit processor 107 in order to verify and store transaction history data. The audit processor 107 is configured to store, in database 107a, the identity of the user who initiated the transaction command, where the user initiated the transaction command, when the user initiated the transaction, and how the user initiated the transaction command. Thus, the audit processor maintains a record of the transaction and the additional information, for example, auditing purposes. An auditor may investigate the record created by audit processor 107 to determine if the transaction was proper.

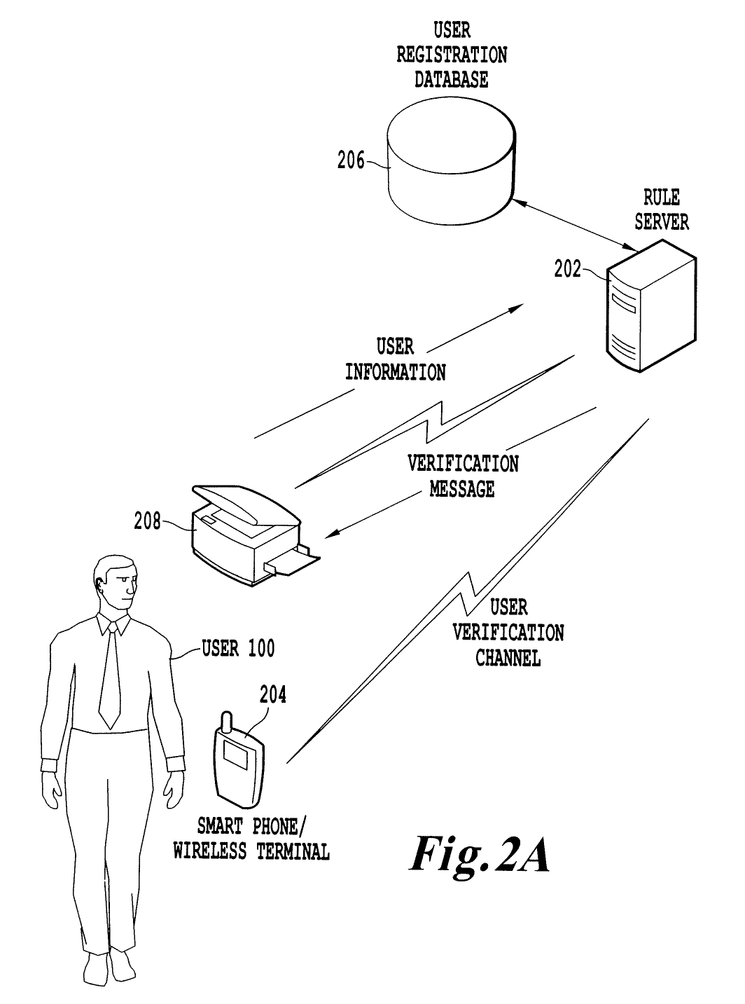

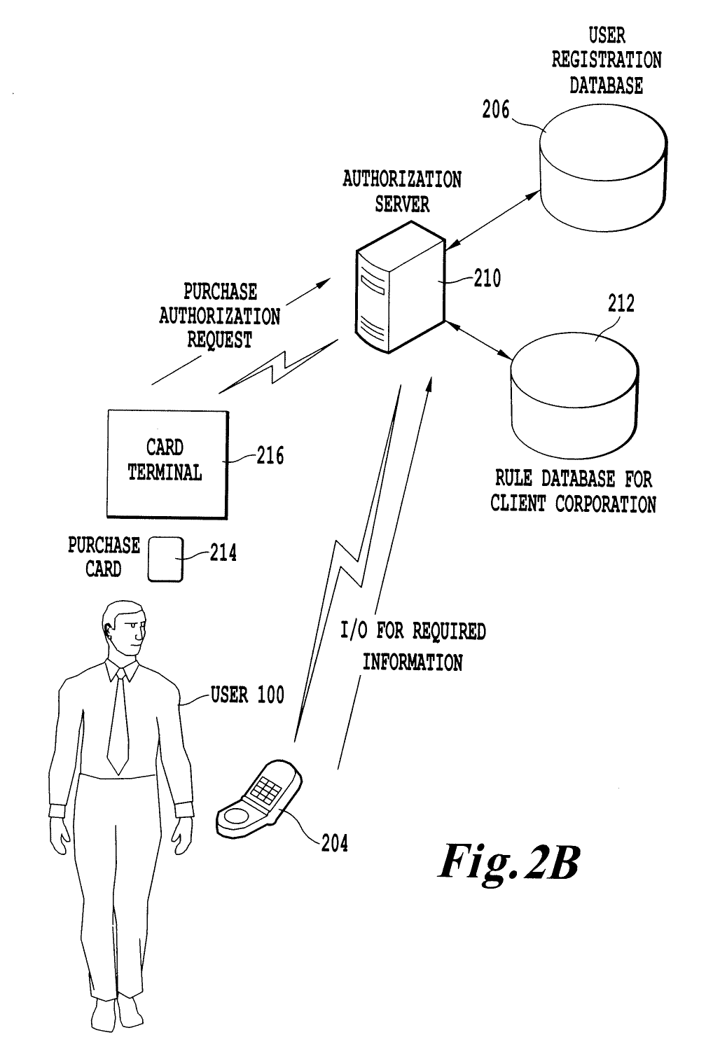

FIG. 2A is diagram illustrating a non-limiting embodiment of the present invention which pertains to secure printing. However, the present invention is also applicable to other image forming devices such as a facsimile machine, a scanner, and a multi-function device that prints, scans, and send/receives faxes. In the embodiment shown in FIG. 2A, the user 100 is attempting transact with printer 208 to print a secure document. The rule server 202 includes a rule which indicates that a pin number must be requested, received, and verified from the user before the printer can begin and complete the printing of this particular secure document. The document is registered at the rule server 202 as the secure document that requires print request by the authorized person and printout to be picked up by the authorized person. The rule server 202 then calls the user's cell phone 204 and transmits a verification message to the user's cell phone 204. The rule server's authorization message will prompt the user for the pin number and print authorization (Yes, proceed with the transaction or No, do not proceed with the transaction). The user will use his cell phone's key pad to enter the pin number and response to the print authorization request. In an alternative embodiment of the present invention, the rule server 202 is configured to accept voice commands, where the user speaks his pin number and print authorization into his cell phone. In other embodiments, the rule server 202 sends an email to the user or a text message. The user 100 can then send an email to the rule server or a text message to the rule server. The rule server 202 may parse the received email or text message for the requested additional information.

Furthermore, the user must not necessarily reply to the rule server using the same means of communication used by the rule server. For example, the user may receive an email requesting additional information, and the user can use his cell phone to call-in the requested additional information.

The rule server, upon receiving the requested additional information (e.g., the pin number and print authorization), verifies the pin number. The rule server compares the received pin number to a pin number stored in a database 206 in correspondence with the user's name or other identifier. If verification is successful (i.e., the received pin number matches the pin number on file) and the user authorizes printing, the rule server sends a verification success message to the printer. Otherwise, a verification failure message will be sent to the printer.

In this embodiment of the present invention, the rule server 202 obtains the cell phone number of the user from the user registration database 206. Prior to implementing the system, the user will register with the system. The user may supply contact information (cell phone number (primary and secondary), email address, etc.) and a pin number or password. The rule server can use the information stored in the user registration database to contact the user and to verify the pin or password entered by the user.

Thus, embodiments of the present invention enable a user to authorize the printing of a secure document from any location. Furthermore, the location of the printer 208 is unrestricted. In addition, embodiments of the present invention automatically create an audit record that can be reviewed by an auditor to determine if there has been any misuse of confidential information. For example, after the PIN number is verified, the user authorizes the printing and the document is printed, an audit processor can create an audit report that may include at least one of a copy of the document, a document identifier, user's identity, the information supplied by the user (i.e., PIN and/or other supplied information), and PIN verification. Thus, an auditor can easily track the transaction and review it for informalities.

In the previous exemplary embodiment, a PIN number and print authorization were used as the additional information. However, the additional information may be a statement by the user regarding the purpose of his printing of the document. The authorization server may record and store this recorded statement. The recorded statement may be reproduced by an auditor, investigating the transaction at issue. Furthermore, the authorization server can be configured to receive and process voice commands using voice recognition software. Appropriate voice recognition software is known to persons of ordinary skill in the art.

Furthermore, other exemplary embodiments of the present invention do not condition the actual printing of the document on the successful verification of the additional information. In an embodiment of the present invention that merely records a statement from the user, the print job may proceed (i.e., be authorized to proceed) because additional information was supplied. The veracity of the additional information can subsequently be verified by an auditor reviewing the created audit report. This embodiment of the present invention may be employed where the document being printed has a lesser restrictions placed on it.

Furthermore, in an alternative embodiment of the present invention, rule server and user registration database may be included in the image forming device.

FIG. 2B illustrates a case where a user uses a purchase card 214 issued by a company. A purchase card 214 may be a credit card, debit card, or gift card. The purchase card 214 may be read using a magnetic strip or bar code reader 216. In an example using a purchase card with a magnetic strip, when the user swipes the purchase card 214 through a magnetic strip reader 216 at a point of sale, the magnetic strip card reader transmits information read from the card to an authorization server 210. The authorization server 210, upon receiving the information from the card reader, accesses a rules database 212 to determine if the particular transaction requires additional information before authorization may be granted.

The rules database 212 may store rules pertaining to the amount of the purchase, the store where the purchase is made, where (geographically) the purchase is being made, and the item/services being purchased.

In an example where the rule server stores 212 a rule pertaining to price, additional information will be necessary if the purchase price exceeds a predetermined amount. If the rule server determines that the purchase price received from the card reader exceeds the predetermined amount, the server accesses a user registration database.

The user registration database 206 stores information pertaining to how to contact the user. For example, the user registration database stores a user's cell phone number, pager number, email address, or other available means for contacting the user. In an exemplary embodiment, the authorization server retrieves the user's cell phone number and uses the cell phone number to contact the user's cell phone and request the additional information.

Additional information may take the form of a password or PIN, mother's maiden name, pet's name, or any other predetermined information that may be used to authenticate the user. In addition, an explanation of the purchase may be required. In an example where a meal is being charged to a corporate credit card, the names of business meal attendants may be requested.

In one embodiment of the present invention, the additional information may take the form of a voice print to identify the user. The authorization server will record the user's voice and then authenticate the voice print to confirm the user's identity before more information is requested. Such voice recognition software is known to persons of ordinary skill in the art.

In one embodiment of the present invention, the authorization server employs an automated telephone system to verbally make a request for the additional information. In response, the user can make a verbal response or use the key pad of a communication device to enter the response.

In another embodiment of the present invention, the authorization server retrieves the user's email address and sends the user an email requesting additional information. The user receives the email through his mobile communication device, which is configured to receive and send emails. The user can then supply the additional information by return email. The authorization server is configured to parse the reply email and extract the requested information. Alternatively, in another embodiment of the present invention, the user may reply to the email by making a phone call, accessing an automated telephone system of the authorization server, and providing the additional information through the telephone key pad.

Once the authorization server receives the additional information, the authorization server authenticates the received additional information to confirm the identity of the user before more information is processed. For example, if a PIN and the reason for the purchase are being used as the additional information, the authorization server determines if the received PIN matches the PIN corresponding to the user in the user registration database. If the received additional information matches the PIN corresponding to the user and the reason for the purchase is stored for further processing, then the authorization server contacts the point of sale and authorizes the completion of the transaction. If there is not a match of the PIN, the transaction is not authorized.

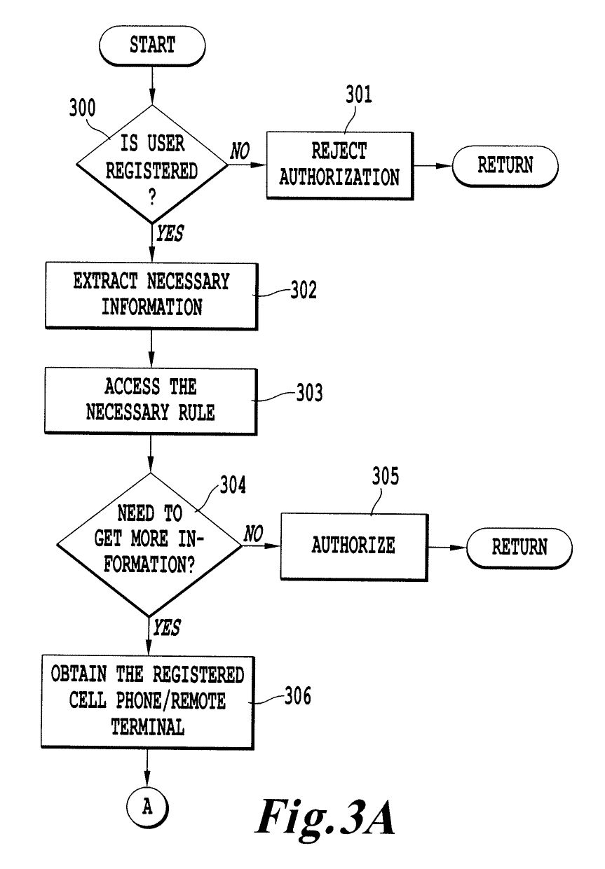

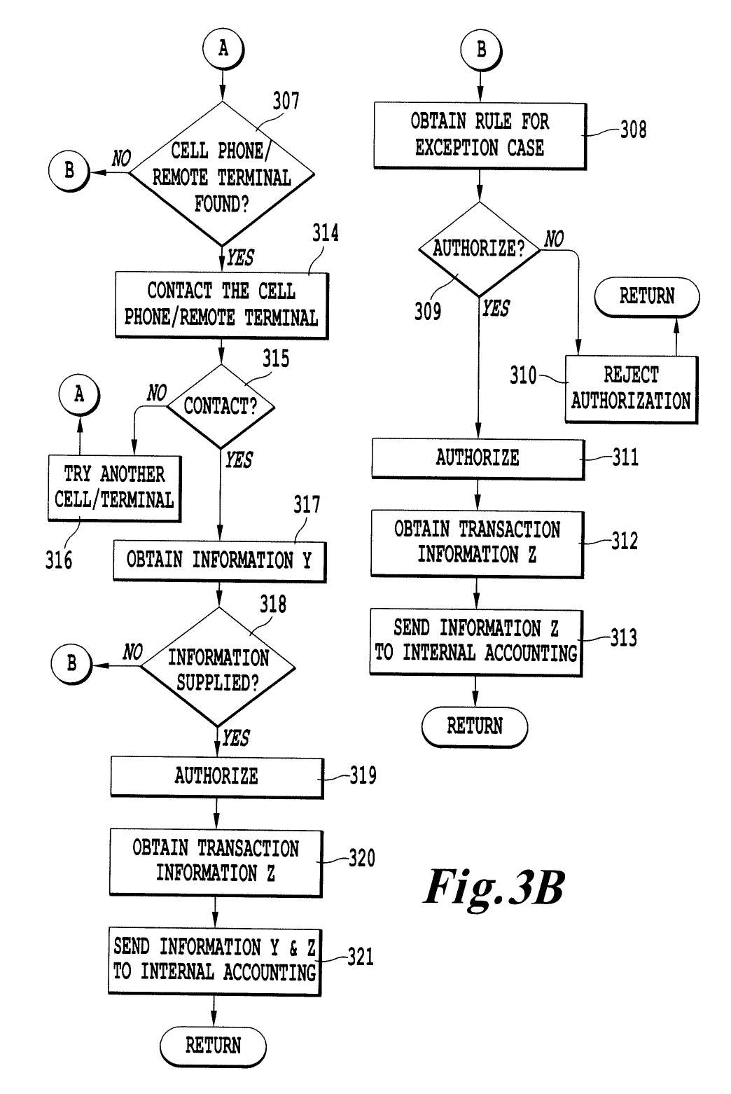

FIGS. 3A and 3B are a flow chart depicting the operation of a system embodying the present invention. In step 300, it is determined whether the user is registered with the authorization server. If the user is not registered, the process proceeds to step 301 and the authorization server rejects the authorization. If the user is registered, then the process proceeds to step 302. In step 302, the authorization server extracts information regarding the transaction. The information that is extracted may include user information, or information pertaining to a transaction using a purchase card such as price. In step 303, the authorization server access a rules database, and using the extracted information, determines if any rules stored in the rules database are applicable. In step 304, an applicable rule or rules are applied, and the authorization server determines if additional information is needed from the user. If the authorization server determines if the applicable rule or rules do not require additional information from the user, the process proceeds to step 305 and the transaction is authorized to proceed. If the authorization server determines that additional information is required, the process proceeds to step 306. In step 306, the authorization server accesses a user registration database to obtain information to contact the user. Such information may be a cell phone number, an email address, or any information used to contact the user's mobile terminal. In step 307, it is determined whether a cell phone number of the user is found in the user registration database. If the authorization server fails to obtain information used to contact the user (a cell phone number for example), the process proceeds to step 308.

In step 308, the authorization server accesses the rules database in order to obtain a rule for the exception case where there is no contact information for a registered user. This rule may be only applicable to this particular user. Furthermore, a user may have a plurality of rules for when the authorization server cannot access contact information. The plurality of rules may vary according to the nature of the transaction at issue. In an alternative embodiment, the system may implement a global rule for all registered users if no contact information is available.

In step 309, the authorization server implements the rule obtained in step 308 and determines if the transaction at issue should be authorized. If the transaction should not be authorized, then the process proceeds to step 310, and the authorization is rejected. If the transaction should be authorized, then the process proceeds to step 311.

In step 311, the authorization server authorizes the transaction. In step 312, the authorization server obtains the transaction information and creates a record of the transaction. In step 313, the created record of the transaction is sent to internal accounting, where the transaction may be audited and reviewed.

Returning now to step 307, if contact information (such as a cell phone number) is obtained from the user registration database, the process proceeds to step 314. In step 314, the authorization server uses the contact information to contact the user. In a non-limiting embodiment of the present invention where the contact information is a cell phone number, the authorization server calls the cell phone of the user.

In step 315, if contact is not established using the obtained contact information, the process proceeds to step 316, and an attempt is made to obtain different contact information for the user, such as secondary cell phone number or an email address.

If contact is made in step 315, then the process proceeds to step 317. In step 317, the additional information is obtained from the user. In step 316, the authorization server authorizes the transaction if the additional information supplied by the user is verified. The process of verifying the information supplied by the user means comparing the information to previously stored information to determine if there is a match. In addition, other information such as the reason for purchase is submitted. If there is a match, then the data is considered to have been verified. If any information is missing, the flow goes to B.

In step 318, it is determined whether the information is supplied. If the information is not supplied, the process goes to B, and begins with step 308. If the information is supplied, then the process proceeds to step 319. In step 319, the authorization server authorizes the transaction.

In step 320, the authorization server obtains the transaction information and the requested information and creates a record of the transaction. In step 320, the created record of the transaction is sent to internal accounting, where the transaction and supplied information may be audited and reviewed.

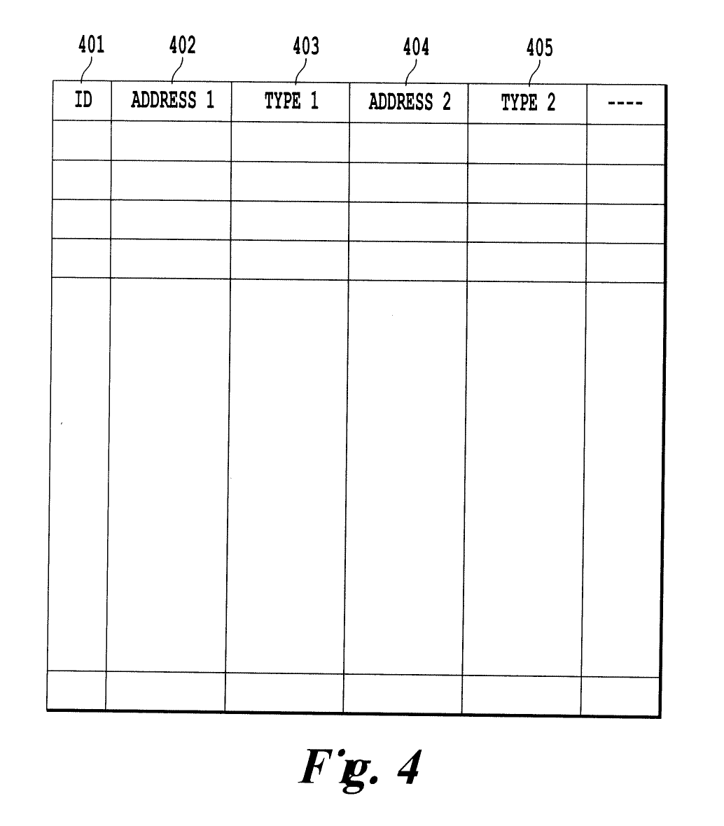

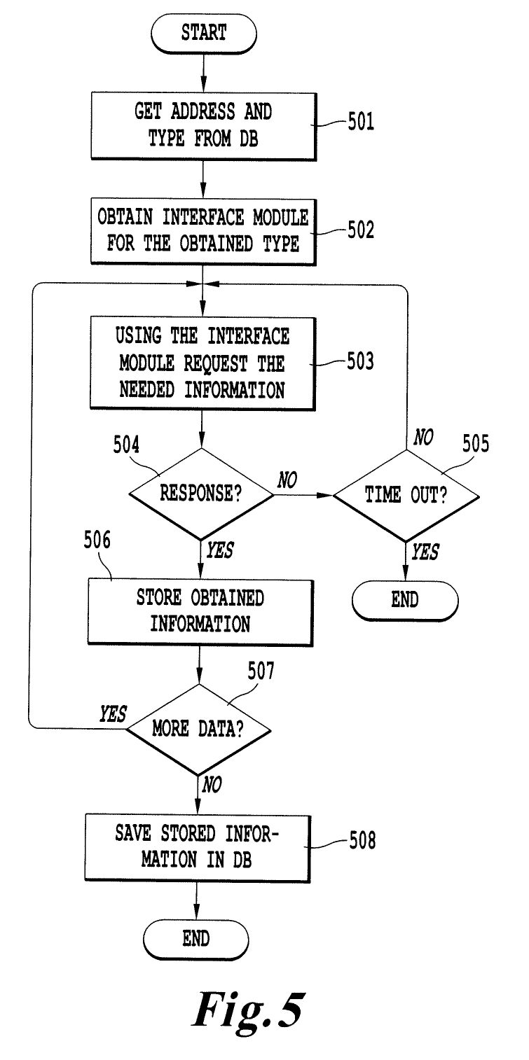

FIG. 4 is an exemplary database for storing user registration information. Column 401 indicates the identifier (or ID) of the users. The ID may be a name, numerical identifier, etc. Column 401 represents an address corresponding to the ID. The address may be any information used to contact the user. Column 402 includes an address used to contact the user. Preferably, the address is information to contact a mobile communication device of the user, or to contact the user in such a manner that his mobile communication device is capable of receiving the message. For example, the address may be a cell phone number or an email address. In the case of an email address, the mobile communication device is configured to access the user's email account corresponding to the email address in FIG. 4. Column 403 indicates the type of address in column 402. Thus, column 403 may indicate the type of cell phone or mobile communication device the user has. This information can be used by an authorization server to determine an appropriate interface module to use when contacting the mobile communication device. For example, if the mobile communication device is a cell phone with a numeric key pad, the then the authorization server can determine that a numeric response can be entered. If the mobile communication device includes a numeric key pad and a QWERTY key pad, then the authorization server can determine that an alpha-numeric response can be entered. This will be further discussed below with reference to FIG. 5.

Columns 404 and 405 indicate address 2 and type 2. Columns 404 and 405 include secondary information that is of the same category as the information in Columns 402 and 403. For example, if a system embodying the present invention initially tries to contact the user by using the information for address 1 and type 1, and this is unsuccessful (i.e., contact is not made with the mobile communication device), the system can use the information for address 2 and type 2 to contact the mobile communication device of the user.

In addition, the table shown in FIG. 4 may include more than two addresses. For example, a user may have multiple cell phones or other mobile communication devices where he may be reached. In addition, the table shown in FIG. 4 can rank the address in order of preference.

In the market place today, there are a plurality of mobile communication devices. These various mobile communication devices have different user interfaces. Some devices have alpha numeric keys. Some devices only have the conventional telephone key pad, with 10 numeric keys (0-9) and a few extra keys (i.e., star key and pound key). Because of these different user interfaces, a different user interface module must be used to communicate with the user so as to be able to receive and recognize the necessary information. Furthermore, the system can use information pertaining to the interface of the mobile communication device to determine the keys available to the user to provide the requested additional information.

FIG. 5 shows an exemplary process, used by a system embodying the present invention, to obtain and use an interface module to obtain additional information through the use of a user's mobile communication device.

In step 501, an address (such as a cell phone number) and type of device the user has (i.e., a Blackberry™ mobile communication device) are obtained from a database. Based on the obtained type, an authentication server obtains an interface module corresponding to the obtained type of device in step 502. The interface module may be obtained from a database. This database may be the same database that stores the address and type, or may be a different database. Furthermore, the authentication device may use a network connection and obtain the requisite interface from a website of the manufacturer of the mobile communication device.

In step 503, the authentication server uses the obtained interface module to request the additional information. In step 504, the authentication waits for and determines if a response to the request has been received. If no response is received after a predetermined time period, the process proceeds to step 505 and times out. If a response is received, then the process proceeds to step 506. In step 506, the received information is temporarily stored in a data buffer. In step 507, the authorization server determines if additional information is needed. If additional information is needed, the process returns to step 503. If no additional information is needed, the process proceeds to step 508, and the information temporarily stored is saved in a database.

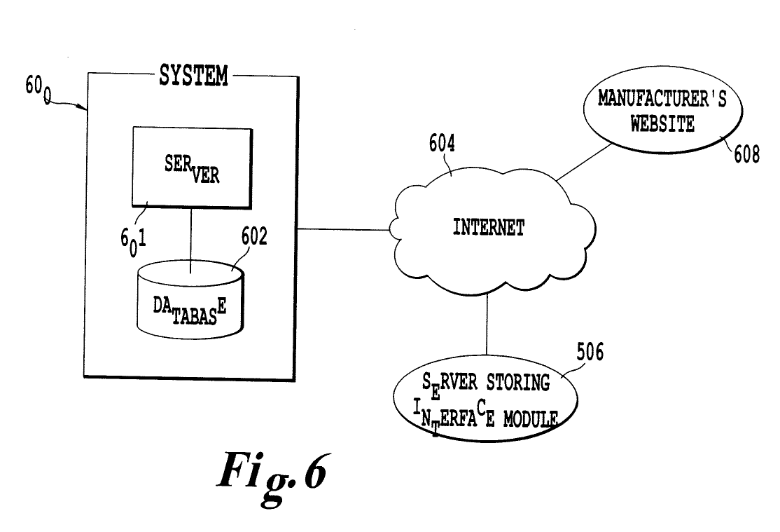

FIG. 6 is a block diagram that shows an example of how an embodiment of the present invention may obtain an interface module. System 600 is a system embodying the present invention. For example, system 600 may correspond to one of the systems shown in FIGS. 1-2B. System 600 includes a server 601 and a database 602. The server is configured to access database 602 and to determine the type of the mobile communication device of the user that will be contacted in order to obtain additional information. Furthermore, server 601 is configured to determine if the database stores an interface module to use to communicate with the user's mobile communication device. If the interface module is stored in database 602, server 601 will use the interface module to communicate with the user's mobile communication device.

If database 602 does not include the interface module, server 601 is further configured to determine if database 602 includes information on where to obtain the interface module. For example, database 602 may include a URL corresponding to a server 606 that stores the interface module. Alternatively, system 600 may access the website 608 of the manufacturer of the mobile communication device in order to obtain the interface module.

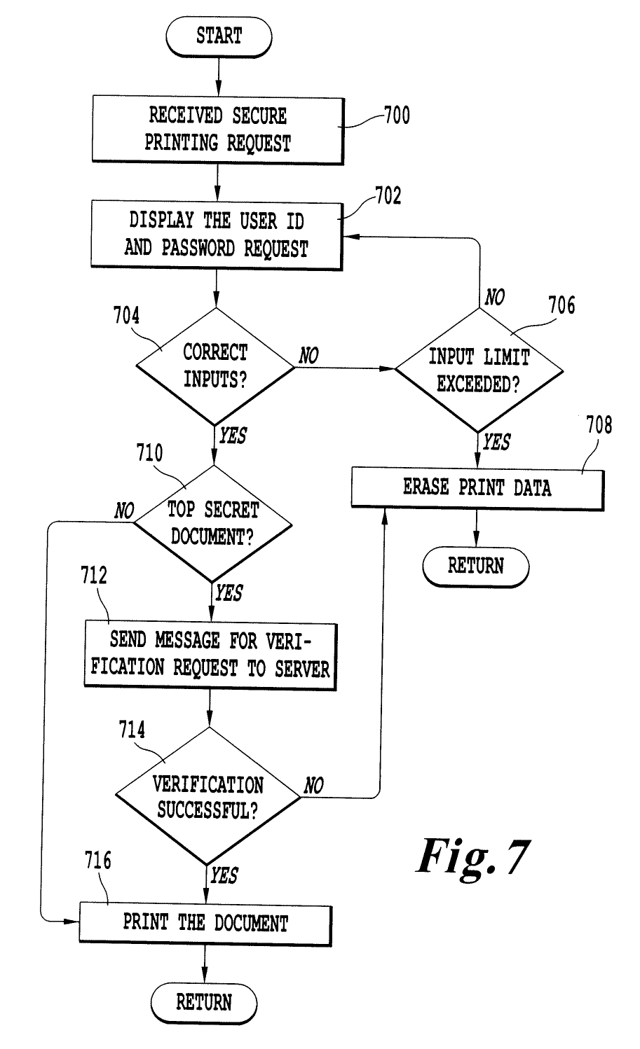

FIG. 7 is a flow chart illustrating a method of inputting a user name and password that are requested to be input at image forming device prior to print out. In step 700, an image forming device (such as a printer, a copier, facsimile machine, or multifunction device) receives a secure printing request. In step 702, a request to supply a user ID and password is displayed. In one embodiment of the present invention, the request to supply the user ID and password is displayed on a display panel of the image forming device. In other embodiments of the present invention, the request to supply the user ID and password may also be displayed on a user's mobile communication device.

In step 704, it is determined whether the correct user ID and password are input. A database may store user ID's in correspondence with passwords. The entered password and user ID can be compared to the information stored in the database. If the inputs are not correct, the process proceeds to step 706.

In step 706, it is determined whether a limit for entering the requested user ID and password has been exceeded. A manager or system administrator may set a limit on the number of times a user may attempt to enter a user ID and password. If the limit has been exceeded, the process proceeds to step 708. In step 708, the print data is erased from the buffer of the image forming device in which it is stored. If the limit is not exceed, the process returns to step 702, and the user is given another opportunity to enter the user ID and password.

In step 704, if the correct inputs are entered, the process proceeds to step 710. In step 710, it is determined whether the document is top secret or of a high security designation. The document itself, in its electronic form, may include metadata that indicates a designation of top secret. Alternatively, a database may store document names in correspondence with a security designation. This database may be accessed to determine the security status of the particular document to be printed. If the document is determined not to be top secret, the process proceeds to step 716 and the document is printed. If the document is determined to be top secret, the process proceeds to step 712.

In step 712, a message for verification is sent to the rule server. The document, being of top secret status, is registered at the rule server. A rule may be in place that requires the rule server to contact the user, via the user's mobile communication device, and request additional information. The additional information may be a request for an explanation as to why the document is being printed. In addition, the rule server contacts the user through his mobile communication device to receive print authorization (yes or no). If verification is unsuccessful (i.e., the user inputs “no” in response to a request for print authorization or does not respond), the process proceeds to step 708, in which the print data is erased from the buffer temporarily storing the print data.

If the verification is successful (i.e., the user inputs “yes” in response to the request for print authorization), the process proceeds to step 716. In step 716, the document is printed.

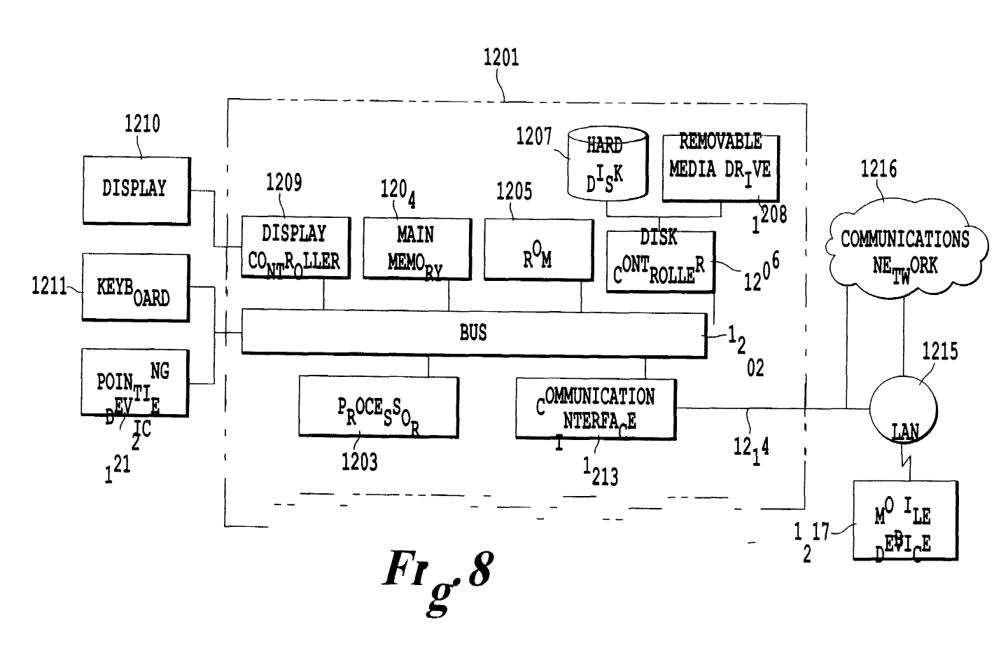

FIG. 8 illustrates a computer system 1201 upon which an embodiment of the present invention may be implemented. Computer system 1201 may be used in conjunction with the exemplary embodiments of the present invention shown in FIGS. 1-2B. However, not every feature shown in FIG. 7 may be in every embodiment of the present invention.

The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT) or LCD, for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

In an exemplary embodiment of the present invention, the computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM, DVD, or a high definition DVD), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cell telephone.

Obviously, numerous modifications and variations of the present invention are possible in light of the above teachings. It is therefore to be understood that within the scope of the appended claims, the invention may be practiced otherwise than as specifically described herein.

1. A method of requesting information, comprising:
receiving a request to process a transaction;
identifying a user that sent the request;
obtaining a rule corresponding to the transaction;
determining, based on the rule corresponding to the transaction and the identity of the user, that information needs to be obtained from the user before the transaction can be processed;
accessing a database to obtain information corresponding to a mobile communication device of the user, the information indicating a contact address for the mobile communication device;
contacting the mobile communication device using the information obtained from the database; and
requesting additional information from the user.

2. The method of claim 1, wherein the determining step comprises:
storing the contact address of the mobile communication device in correspondence with the identity of the user.

3. The method of claim 1, wherein the transaction is processing information on an image forming device.

4. The method of claim 1, wherein the transaction is processing information used in a purchase card transaction.

5. The method of claim 1, further comprising:
determining whether the additional information matches data stored for the user;
processing the transaction if the additional information matches information; and
creating an audit record that includes at least one of an identity of the user, the additional information, and data related to the transaction.

6. The method of claim 1, further comprising:
determining a type of the mobile communication device; and
obtaining, based on the determined type of the mobile communication device, an interface module used to communicate with the mobile communication device.

7. A system for requesting information, comprising:
a target unit configured to
receive a request to process a transaction,
identify a user that sent the request,
obtain a rule corresponding to the transaction,
determine, based on the rule corresponding to the transaction and the identity of the user, that information needs to be obtained from the user before the transaction can be processed,
access a database to obtain information corresponding to a mobile communication device of the user, the information indicating a contact address for the mobile communication device,
contact the mobile communication device using the information obtained from the database, and
request additional information from the user; and
a mobile communication device configured to supply the additional information to the target unit.

8. The system of claim 7, wherein the target unit is configured to store the contact address of the mobile communication device in correspondence with the identity of the user.

9. The system of claim 7, wherein the transaction represents a process to be performed by an image forming device.

10. The system of claim 7, wherein the transaction represents a process to be performed in a purchase card transaction.

11. The system of claim 7, wherein the target unit is configured to
determine whether the additional information matches data stored for the user;
process the transaction if the additional information matches information; and
create an audit record that includes at least one of an identity of the user, the additional information, and data related to the transaction.

12. The system of claim 7, wherein the target unit is configured to
determine a type of the mobile communication device; and
obtain, based on the determined type of the mobile communication device, an interface module used to communicate with the mobile communication device.

13. A computer program product encoded with instructions, which when executed by an information processing apparatus cause the information processing apparatus to perform a method of requesting information, the method comprising:
receiving a request to process a transaction;
identifying a user that sent the request;
obtaining a rule corresponding to the transaction;
determining, based on the rule corresponding to the transaction and the identity of the user, that information needs to be obtained from the user before the transaction can be processed;
accessing a database to obtain information corresponding to a mobile communication device of the user, the information indicating a contact address for the mobile communication device;
contacting the mobile communication device using the information obtained from the database; and
requesting additional information from the user.

14. The computer program product of claim 13, wherein the determining step comprises:
storing the contact address of the mobile communication device in correspondence with the identity of the user.

15. The computer program product of claim 13, wherein the transaction is processing information on an image forming device.

16. The computer program product of claim 13, wherein the transaction is processing information used in a purchase card transaction.

17. The computer program product of claim 13, wherein the method further comprises:
determining whether the additional information matches data stored for the user;
processing the transaction if the additional information matches information; and
creating an audit record that includes at least one of an identity of the user, the additional information, and data related to the transaction.

18. The computer program product of claim 13, wherein the method further comprises:
determining a type of the mobile communication device; and
obtaining, based on the determined type of the mobile communication device, an interface module used to communicate with the mobile communication device.

19. A system for requesting information, comprising:
means for receiving a request to process a transaction;
means for identifying a user that sent the request;
means for obtaining a rule corresponding to the transaction;
means for determining, based on the rule corresponding to the transaction and the identity of the user, that information needs to be obtained from the user before the transaction can be processed;
means for accessing a database to obtain information corresponding to a mobile communication device of the user, the information indicating a contact address for the mobile communication device;
means for contacting the mobile communication device using the information obtained from the database; and
means for requesting additional information from the user.
